(19) United States
(12) Patent Application Publication
(10) Pub. No.: US 2005/0188343 A1
(43) Pub. Date: Aug. 25, 2005

(54) Operation of a java virtual machine

(75) Inventor: Richard J. Houldsworth, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/516,893

(22) PCT Filed: Jun. 4, 2003
(86) PCT No.: PCT/IB03/02581

(30) Foreign Application Priority Data
Jun. 8, 2002 (GB) 0213218.1

(51) Int. Cl. G06F 9/455

(52) U.S. Cl. 717/100; 718/1

(57) ABSTRACT

A method for operating a JAVA virtual machine comprises loading a module comprising a parent JAVA class file, identifying offspring JAVA class files listed within the parent JAVA class file, and preloading the offspring JAVA class files. Apparatus arranged to carry out this method comprises receiving means for receiving a digital broadcast signal, and processing means for processing the signal, the processing means comprising a JAVA virtual machine.

This invention relates to a method for operating a JAVA virtual machine and to apparatus arranged to carry out the method. In particular, the apparatus is a digital receiver for receiving a digital broadcast signal.

A digital receiver, such as a set top box, receives a digital broadcast signal that typically comprises video, audio and data components. The data component is provided in a repetitive “carousel” type manner, with modules being downloaded by the receiver as and when they are required. The modules typically contain interactive applications written in the JAVA programming script. The digital receiver is provided with a JAVA virtual machine (JVM) and receives JAVA class files that it links and executes to run the interactive application.

The relatively low data rate presently used by the broadcasters, however, leads to a detectable delay in data transfer. For example, a user requesting a particular interactive application will frequently have to wait several seconds for the application to begin running, and in many instances will suffer further delays while the application is running.

U.S. Pat. No. 5,966,162 discloses a method and apparatus for masking the effects of latency within an information distribution system. The apparatus disclosed comprises a set top terminal that requests and receives information from a server within the system. The information is generally displayed upon a conventional television that is coupled to the set top terminal. The terminal contains a central processing unit and an information stream decoder that are programmed to implement a routine which is executed when a subscriber selects certain functions, usually via a remote control, that are available for the set top terminal to perform. Upon execution, the method recalls a predefined image (e.g. a white screen) from memory and begins to fade the displayed image into the predefined image. Simultaneously, the playing sound is also faded to no sound. The decoder within the set top terminal is reset to flush from its buffer any residual sound or video information from the previously decoded video. Lastly, once the new video stream has arrived and begins to be decoded, the set top terminal fades up from the predefined image to the new video stream and from the predefined audio to the audio stream that accompanies the video stream. At this point, the subscriber's selected function has been fully implemented without display of the detrimental effects usually associated with a latency delay. However the solution proposed by this patent relates only to the delay in receiving video and audio streams, and does not in any way reduce the time delay, simply attempting to mask the delay, so it is less apparent to the user.

It is therefore an object of the invention to improve upon the known art.

According to the first aspect of the invention, there is provided a method for operating a JAVA virtual machine comprising loading a module comprising a parent JAVA class file, identifying offspring JAVA class files listed within said parent JAVA class file, and preloading said offspring JAVA class files.

According to the second aspect of the invention, there is provided apparatus arranged to carry out the above method, comprising receiving means for receiving a digital broadcast signal, and processing means for processing said signal, said processing means comprising a JAVA virtual machine.

Owing to the invention, it is possible to operate a JAVA virtual machine to optimise the loading and preloading of JAVA class files, with the consequent timesavings that result. When used, for example, in a digital television receiver, this results in a faster handling of the data portion of the digital broadcast signal.

Advantageously, the loading comprises loading the module from the data portion of a digital broadcast signal. Preferably, the preloading is carried out according to priority and comprises examining further modules for the presence of identified offspring JAVA class files and preloading said offspring JAVA class files accordingly.

The parent JAVA class file can be executed concurrently with the preloading. The method may preferably further comprise identifying suboffspring JAVA class files listed within the offspring JAVA class files.

The apparatus may be a set top box or a digital television. Advantageously, the JAVA virtual machine comprises a computer program or is at least partially implemented in hardware.

The use of the expressions parent, offspring and suboffspring JAVA files does not imply any hierarchical relationship between the different JAVA files, but is used to define the relationship between one JAVA file that refers to another. One JAVA class file that needs to fetch another JAVA class file to link and execute that file could be a parent JAVA addressing an offspring JAVA file, or could be an offspring JAVA class file addressing a suboffspring JAVA class file.

Embodiments of the invention will now be described, by way of example only, with reference to the accompanying drawings, in which:—

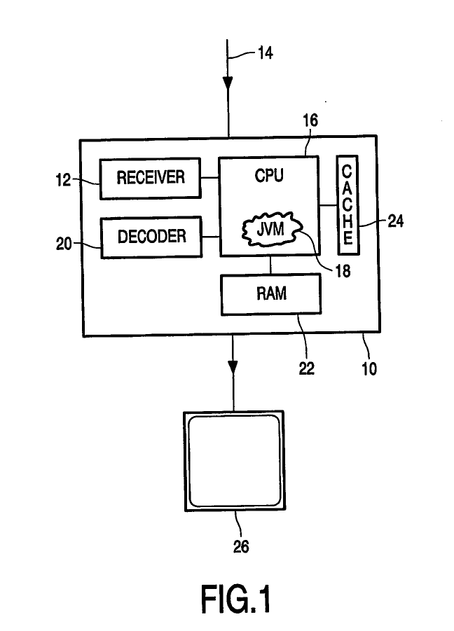

FIG. 1 is a schematic diagram of a set top box connected to a display device, and

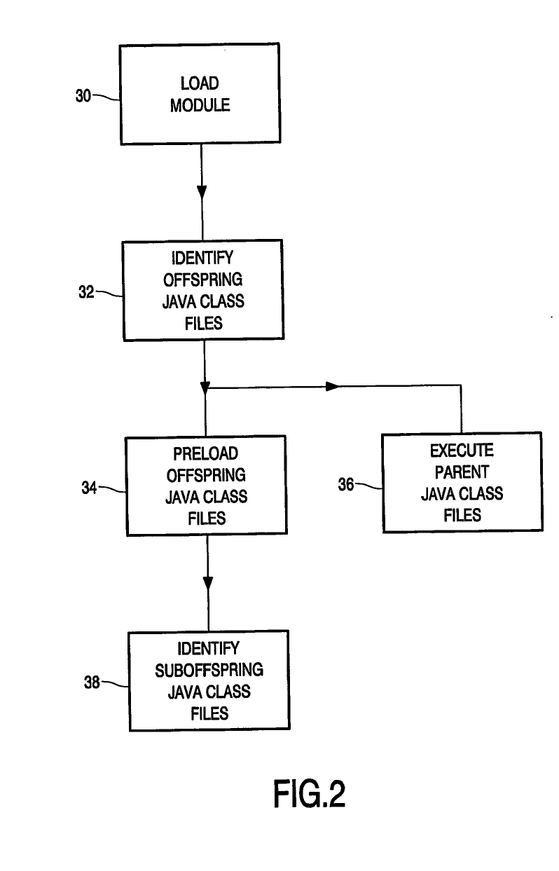

FIG. 2 is a flow diagram of a method for operating a JAVA virtual machine.

In FIG. 1, the set top box 10 comprises receiving means, in the form of a receiver 12 for receiving a digital broadcast signal 14. The set top box also comprises processing means, in the form of a CPU 16, for processing the signal 14. The processing means 16 comprises a JAVA virtual machine (JVM) 18. The JVM is a computer program that is run by the CPU 16. The JVM is hardware and operating system independent, and allows JAVA applets to be run by the set top box 10.

The set top box additionally includes conventional components such as a decoder 20, a RAM 22 and a cache memory 24. The decoder demultiplexes the broadcast signal 14. The video component is passed to the display device 26, and the audio component is passed to audio speakers (not shown). A user of the set top box 10 selects, via a suitable user interface, the channel that they wish to watch, and the appropriate content is acquired and provided to the user.

If the user wishes to access any interactive applications through their set top box 10, then again this functionality is available via the user interface, typically a remote control. These interactive applications are such things as electronic program guides, “teletext” type information, and applications that relate to the subject matter being broadcast. This latter type of application would be, for example if the user was watching coverage of a golf tournament, detailed diagrams of each hole of the course, statistics on the golfers participating, a real time leaderboard, etc. Applications that involve two-way communication are also possible, for example shopping and betting. The set top box 10 is provided with a back channel, normally via the telephone network to facilitate this two-way communication.

However, the software for running these interactive applications is delivered to the set top box 10 via the data component of the broadcast signal 14, which signal has limited bandwidth. The JAVA applets that make up the interactive applications are dedicated to each broadcast channel and are broadcast repetitively by the transmitter in a carousel form. Once a user selects an interactive application, the set top box must begin acquiring the necessary JAVA applets to be able to execute the application.

The method of FIG. 2 is initiated when the set top box 10 requests an interactive application. The method first comprises the step 30 of loading a module comprising at least one parent JAVA class file. The module is loaded from the data portion of the digital broadcast signal 14, and cached by the set top box 10 in the cache 24. The module is one of a number of modules that form the carousel that is repetitively transmitted by the broadcaster of the digital television signal 14, thereby making up the data component of the signal 14.

The interactive application requested by the set top box 10 is composed of a number of JAVA class files, with a parent JAVA class file being addressed by a JAVA virtual machine (JVM) within the set top box 10. The parent JAVA class file may make up an entire module, or may be part of a module. Once the parent JAVA class file is linked and being executed by the JVM, further JAVA class files will be addressed. These offspring JAVA class files may be in the original module, which is cached in the cache 24, or may be in different modules of the carousel, which are therefore still to be loaded by the set top box 10.

However to facilitate acceleration of this process, once the parent JAVA class file is loaded, the step 32 of identifying offspring JAVA class files listed within the parent JAVA class file is carried out. The CPU 16 examines the parent JAVA class file to create a list of JAVA files that can be addressed by the parent class file. The offspring files may relate to JAVA code that are run following options chosen by the user in the interactive application, or could be further applets that are run automatically by the parent JAVA file. Once the parent JAVA class file is linked and executed, the offspring files may be required during the running of the interactive application.

Following completion of the identifying of the offspring JAVA class files listed within the parent class file, the step 34 of preloading the offspring JAVA class files is carried out. The preloading comprises examining further modules for the presence of identified offspring JAVA class files and preloading the JAVA class files accordingly. The CPU 16, via the receiver 12 and decoder 20, examines each module contained within the data carousel in turn, as the set top box 10 receives them. When the CPU 16 identifies a module that contains an offspring JAVA class file previously identified as being addressed by the parent JAVA class file, the CPU preloads this module to obtain the required offspring JAVA applet.

The parent JAVA class file is executed concurrently with the preloading of the offspring JAVA class files, this stage being illustrated at step 36 in FIG. 2. The JAVA virtual machine 18 running on the CPU 16 has the functionality to link and execute the parent JAVA class file at the same time as the CPU 16 is carrying out the preloading of the offspring files. In effect this means that the set top box 10 executes the selected interactive application as and when it is acquired by the set top box 10 from the data carousel.

Therefore, should the parent JAVA class file require an offspring class file, for example when a user makes a subselection within the interactive application, then the offspring file, if it has been preloaded, will be available instantly to the CPU 16. This ensures that there is no delay in the running of the interactive application, caused by the temporary unavailability of any offspring class file. The preloaded offspring files, which can be stored in the cache 24 or RAM 22, can be recalled, linked and executed by the JVM 18, without delay.

In certain circumstances, the parent JAVA class file may require an offspring JAVA class file that has not yet been preloaded. When this happens, the set top box will acquire modules from the data carousel until the desired offspring file is located, in much the same manner as a conventional set top box. However to reduce occurrence of this delay, the preloading is carried out according to priority. This is an intelligent feature of the identifying step 32.

While the CPU is carrying out the step 32 of identifying the offspring JAVA class files listed in the parent class file, processing of this information takes place to order the offspring class files in a list according to priority. This priority is based upon the likelihood of the order in which the offspring files will be needed by the parent JAVA class file. This priority list is then used to determine the preloading of the offspring JAVA class files. This ensures that there is a reduced chance of the parent class file addressing an offspring file that is not already preloaded.

To further enhance the method for operating the JAVA virtual machine 18, the step 38 is carried out, following, or concurrent with the preloading of the offspring JAVA class files. This step 38 comprises identifying suboffspring JAVA class files listed within the offspring JAVA class files. By identifying the suboffspring files, the JVM 18 is ready, once a preloaded JAVA class file is addressed, to begin preloading the suboffspring files immediately. Again this leads to a reduction in any visible delay in the running of the interactive application.

The JVM 18 is here described as a computer program, but equally it could be at least partially implemented in hardware.

1. A method for operating a JAVA virtual machine comprising loading (30) a module comprising a parent JAVA class file, identifying (32) offspring JAVA class files listed within said parent JAVA class file, and preloading (34) said offspring JAVA class files.

2. A method according to claim 1, wherein said loading (30) comprises loading said module from the data portion of a digital broadcast signal.

3. A method according to claim 1 or 2, wherein said preloading (34) is carried out according to priority.

4. A method according to claim 1, 2 or 3, wherein said parent JAVA class file is executed (36) concurrently with said preloading (34).

5. A method according to any preceding claim, and further comprising identifying (38) suboffspring JAVA class files listed within the offspring JAVA class files.

6. A method according to any preceding claim, wherein said preloading (34) comprises examining further modules for the presence of identified offspring JAVA class files and preloading said offspring JAVA class files accordingly.

7. Apparatus arranged to carry out any one of the method claims 1 to 6, comprising receiving means (12) for receiving a digital broadcast signal (14), and processing means (16) for processing said signal (14), said processing means (16) comprising a JAVA virtual machine (18).

8. Apparatus according to claim 7, wherein said apparatus is a set top box (10).

9. Apparatus according to claim 7, wherein said apparatus is a digital television.

10. Apparatus according to claim 7, 8 or 9, wherein said JAVA virtual machine (18) comprises a computer program.

11. Apparatus according to claim 7, 8 or 9, wherein said JAVA virtual machine (18) is at least partially implemented in hardware.
